(19) United States
(12) Patent Application Publication
(10) Pub. No.: US 2026/0296467 A1
(43) Pub. Date: Oct. 1, 2026

(54) DRIVER INTENTION ESTIMATION DEVICE, DRIVER INTENTION ESTIMATION METHOD, AND NON-TRANSITORY COMPUTER READABLE STORAGE MEDIUM

(71) Applicants: DENSO CORPORATION, Kariya-city (JP); AISIN CORPORATION, Kariya (JP); JTEKT CORPORATION, Kariya-shi (JP)

(72) Inventor: Daisuke NAGASAKA, Tokyo (JP)

(21) Appl. No.: 19/574,855

(22) Filed: Mar. 23, 2026

(30) Foreign Application Priority Data
Mar. 25, 2025 (JP) 2025-050297

(51) Int. Cl. B60W 50/10; B60W 10/04; B60W 10/18; B60W 10/20; B60W 30/12; B60W 30/18; B60W 40/09

(52) U.S. Cl. CPC B60W 50/10; B60W 10/04; B60W 10/18; B60W 10/20; B60W 30/12; B60W 30/18163; B60W 40/09; B60W 2540/18; B60W 2552/10; B60W 2710/18; B60W 2710/20; B60W 2720/10; B60W 2720/106

(57) ABSTRACT

A driver intention estimation device includes: an error calculation unit that sequentially calculates a steering error that is the difference between an ideal steering amount for performing the traffic lane keeping travel and an actual steering amount; a Shannon entropy calculation unit that sequentially calculates a Shannon entropy of a short-term steering error distribution as a steering intention change index, based on a short-term steering error distribution of the steering error in a most recent period; a divergence calculation unit that sequentially calculates a steering error KL divergence, which is a KL divergence between the short-term steering error distribution and a long-term steering error distribution, as the steering intention change index; and a driver intention estimation unit that sequentially estimates the steering intention of the driver based on the steering intention change index and a distribution average of the short-term steering error distribution.

### CROSS REFERENCE TO RELATED APPLICATION

The present application claims the benefit of priority from Japanese Patent Application No. 2025-050297 filed on Mar. 25, 2025. The entire disclosure of the above application is incorporated herein by reference.

### TECHNICAL FIELD

The present invention relates to a driver intention estimation device, a driver intention estimation method and non-transitory computer readable storage medium for estimating a driver intention to change a traffic lane and provide a drive support.

### BACKGROUND

There are known devices that provide a drive support by estimating a driver intention to change a traffic lane of a vehicle. JP 4164095 B teaches a device that provides a drive support by distinguishing between an intentional lane change by the driver and an unintentional lane change. The disclosure of JP 4164095 B is incorporated herein by reference as an explanation of technical elements in the present disclosure.

### SUMMARY

According to an example, a driver intention estimation device includes: at least one of (i) a circuit and (ii) a processor with a memory storing computer program code executable by the processor. The at least one of the circuit and the processor may be configured to cause the driver intention estimation device to: sequentially calculate a steering error that is a difference between an ideal steering amount for performing a traffic lane keeping travel, which is determined based on a shape of a traffic lane on which a vehicle is traveling, and an actual steering amount, which is an amount by which a steering wheel of the vehicle is steered; sequentially calculate a steering intention change index indicating whether a steering intention of a driver of the vehicle is changing based on a short-term steering error distribution that is a distribution of the steering error in a predetermined most recent period set in advance; and sequentially estimate whether the steering intention of the driver is to keep the traffic lane, to maintain an offset in the traffic lane, or to change the traffic lane based on the steering intention change index and a distribution average of the short-term steering error distribution.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing the configuration of a drive support system according to an embodiment; and

FIG. 2 is a diagram showing an example of a flow of a process executed by a driver intention estimation device.

### DETAILED DESCRIPTION

The device disclosed in JP 4164095 B simply distinguishes between whether the driver intends to change a traffic lane and whether the driver does not intend to change a traffic lane. In the actual travelling, even if there is no intention to change a traffic lane, there are cases where the vehicle travels near the center in the traffic lane lateral direction, and cases where the driver intentionally drives the vehicle in a position that is shifted from the center in the traffic lane lateral direction. In this specification, the latter cases are referred to as an offset maintain travel. In this specification, a traffic lane keeping travel does not include the offset maintain travel. Therefore, the traffic lane keeping travel indicates travelling to keep the traffic lane, that is, the travelling without changing a traffic lane, and excludes the offset maintain travel. In addition, the term “travel” may be omitted and the terms “traffic lane keep” and “offset maintain” may be used.

The offset maintain travel is performed, for example, when avoiding contact with a parked vehicle. In the actual travel, the travel without the intention of the driver to change the traffic lane includes the traffic lane keeping travel and the offset maintain travel. Therefore, if the system only distinguishes between whether the driver intends to change a traffic lane and whether the driver does not intend to change a traffic lane, as in Patent Literature 1, there is a possibility that the drive support will be provided that differs from the driver's intention.

The present disclosure has been made based on this point, and its purpose is to provide a driver intention estimation device and a driver intention estimation program that can prevent a drive support from being provided in a manner that differs from the driver's intention.

The above objects are achieved by a combination of features described in the embodiments defining further advantageous embodiments of the disclosure. Note that a reference numeral in parentheses in the embodiments indicate a correspondence relationship with specific means described in embodiments to be described later as one aspect, and does not limit the technical scope of the present disclosure.

To achieve the above object, according to an aspect of the present embodiments, a driver intention estimation device includes: an error calculation unit (182A) that sequentially calculates a steering error(s) that is the difference between an ideal steering amount for performing the traffic lane keeping travel, which is determined based on the shape of the traffic lane on which the vehicle is traveling, and an actual steering amount, which is the amount by which the steering wheel of the vehicle is steered; a steering intention change index calculation unit (183B, 183C) that sequentially calculates a steering intention change index indicating whether the steering intention of the driver of the vehicle is changing based on a short-term steering error distribution that is a distribution of the steering error in a recent period set in advance; and a driver intention estimation unit (184) that sequentially estimates whether the driver steering intention is to keep the traffic lane, to maintain the offset, or to change a traffic lane based on the steering intention change index and the distribution average of the short-term steering error distribution.

To achieve the above object, according to an aspect of the present embodiments, a driver intention estimation program causes a processor to function as: an error calculation unit (182A) that sequentially calculates a steering error(s) that is the difference between an ideal steering amount for performing the traffic lane keeping travel, which is determined based on the shape of the traffic lane on which the vehicle is traveling, and an actual steering amount, which is the amount by which the steering wheel of the vehicle is steered; a steering intention change index calculation unit (183B, 183C) that sequentially calculates a steering intention change index indicating whether the steering intention of the driver of the vehicle is changing based on a short-term steering error distribution that is a distribution of the steering error in a recent period set in advance; and a driver intention estimation unit (184) that sequentially estimates whether the driver steering intention is to keep the traffic lane, to maintain the offset, or to change a traffic lane based on the steering intention change index and the distribution average of the short-term steering error distribution.

These driver intention estimation devices or the driver intention estimation program estimate the driver's steering intention, including not only the traffic lane keeping travel and traffic lane change, but also the offset maintain travel. Therefore, it is possible to prevent the drive support from being provided in a manner that is different from the driver's intention.

The short-term steering error distribution is a distribution of the difference between the ideal steering amount and the actual steering amount in the most recent period, and therefore, if there is a change in the driver's steering intention, there will be a change in the short-term steering error distribution. The driver's steering intention is sequentially estimated from the steering intention change index calculated based on this short-term steering error distribution and the distribution average of the short-term steering error distribution, so that it is possible to accurately estimate whether the driver's steering intention is to keep the traffic lane, to maintain the offset, or to change a traffic lane. Therefore, it is possible to prevent the drive support from being provided in a manner that is different from the driver's intention.

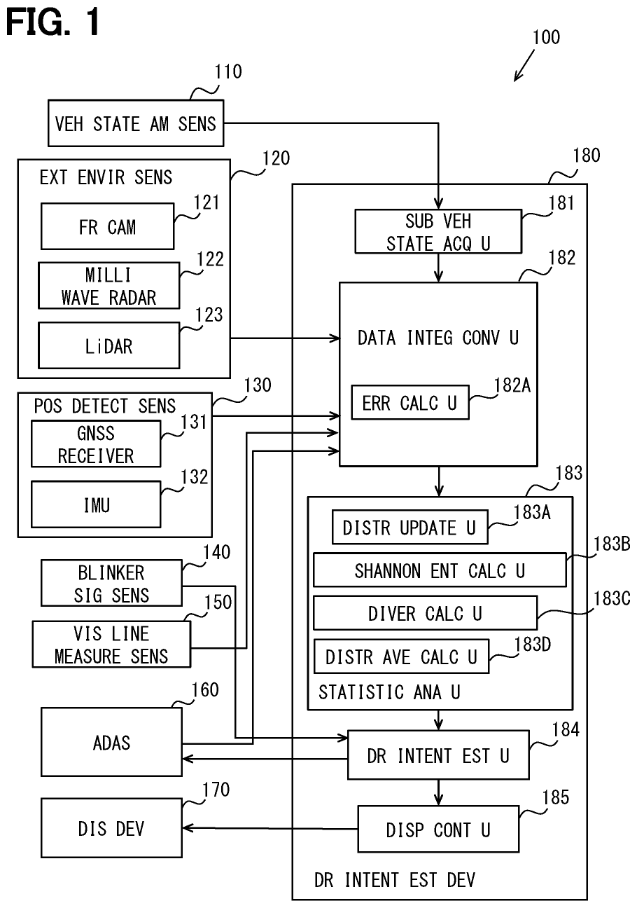

Hereinafter, an embodiment will be described with reference to the drawings. FIG. 1 is a diagram showing the configuration of a drive support system 100 according to an embodiment. The drive support system 100 is mounted on a vehicle. A vehicle equipped with the drive support system 100 is referred to as a subject vehicle. The subject vehicle can be manually driven by the driver, and the speed control and steering control are controlled by the drive support system 100. The drive support system 100 includes a vehicle state amount sensor 110, an external environment sensor 120, a position detection sensor 130, a blinker signal sensor 140, a visual line measurement sensor 150, an ADAS (i.e., Advanced Driver-Assistance Systems) 160, a display device 170, and a driver intention estimation device 180.

The vehicle state amount sensor 110 is one or more sensors that detect various state amounts (hereinafter referred to as “a travel state amount”) that indicate the travelling state of the subject vehicle. The travel state amounts include the vehicle speed, acceleration, and steering angle. The steering angle is the angle of rotation of the steering wheel.

The external environment sensor 120 is a sensor that detects information about the external environment of the subject vehicle. The external environment sensor 120 includes one or more of a front camera 121, a millimeter wave radar 122, and a LIDAR 123. The front camera 121 captures an image of the area ahead of the subject vehicle. The millimeter wave radar 122 emits a millimeter wave ahead of the subject vehicle and receives the reflection wave of the emitted millimeter wave. The LIDAR 123 emits laser light ahead of the subject vehicle and receives reflected light of the emitted laser light. The front camera 121, the millimeter wave radar 122, and the LIDAR 123 are sensors for detecting a lane marking, an obstacle ahead of the subject vehicle, and the like.

The position detection sensor 130 sequentially detects the current position of the subject vehicle. The position detection sensor 130 may include one or both of a GNSS (i.e., Global Navigation Satellite System) receiver 131 and an IMU 132. The GNSS receiver 131 receives a navigation signal transmitted by a navigation satellite included in the Global Navigation Satellite System (i.e., GNSS). Then, the current position is calculated sequentially based on the navigation signal. The IMU 132 is an inertial measurement unit that sequentially acquires the inertial force acting on the subject vehicle. Since the inertial force occurs as the position of the subject vehicle changes, the current position of the subject vehicle is sequentially updated based on the inertial force.

The blinker signal sensor 140 acquires a signal indicating the operation state of the blinker lever, i.e., the direction indicator. A signal indicating the operation state of a direction indicator will be referred to as a blinker signal TS hereinafter. The visual line measurement sensor 150 is a sensor that detects the azimuth angle g of the visual line of the driver.

The ADAS 160 executes the steering control and the speed control of the subject vehicle under a certain condition. The ADAS 160 controls the steering device and the acceleration/deceleration device mounted on the subject vehicle to execute the steering control and the speed control. The acceleration/deceleration device includes a prime mover such as an engine or a motor, a device for controlling the prime mover, a brake, and a device for controlling the brake. The ADAS 160 execute the steering control and the speed control to perform the traffic lane keeping travel function, the traffic lane change function, and the offset maintain travel function. The traffic lane keeping function is a function that keeps the subject vehicle traveling along the lane in which the vehicle is traveling. The traffic lane change function is a function that causes the subject vehicle to change the traffic lane in which the vehicle is traveling. The offset maintain function does not change the traffic lane in which the subject vehicle is traveling, but temporarily changes the position of the subject vehicle in the lateral direction of the traffic lane within the traveling traffic lane toward an adjacent traffic lane, or temporarily changes a position beyond the traffic lane line, for purposes such as avoiding a parked vehicle.

The display device 170 is mounted in a position of the vehicle compartment where the display device 170 can be seen by the driver. The display device 170 is, for example, a meter cluster display or a head-up display.

The driver intention estimation device 180 is a computer, and includes a processor, RAM, and non-volatile memory as hardware components. The non-volatile memory stores a driver intention estimation program executed by the processor. The processor executes the driver intention estimation program to function as a vehicle state acquisition unit 181, a data integration and conversion unit 182, a statistical analysis unit 183, a driver intention estimation unit 184, and a display control unit 185. Furthermore, the processor executes the driver intention estimation program, thereby implementing the driver intention estimation method.

The subject vehicle state acquisition unit 181 sequentially acquires a signal that is prepared by detecting a travel state amount from the vehicle state amount sensor 110. As described above, the travel state amount include the vehicle speed, acceleration, and steering angle.

The data integration conversion unit 182 sequentially acquires the signal indicating the traveling state amount from the subject vehicle state acquisition unit 181. In addition, the data integration conversion unit 182 sequentially acquires external environment data, position detection data, visual line measurement data, and ideal steering amount. The external environment data is data indicating the external environment and is acquired from the external environment sensor 120. The position detection data is data indicating the position of the subject vehicle, and is acquired from the position detection sensor 130. The visual line measurement data is data indicating the azimuth angle g of the visual line of the driver, and is acquired from the visual line measurement sensor 150. The ideal steering amount is the amount of steering required to keep the vehicle to travel in the center of the current traffic lane during the lane keeping travel, and is determined based on the shape of the traffic lane on which the subject vehicle is currently travelling. Since the ideal steering amount is calculated sequentially by the ADAS 160, the data integration conversion unit 182 acquires the ideal steering amount from the ADAS 160.

The data integration conversion unit 182 integrates the various acquired data into data in one coordinate system. The coordinate system is, for example, a subject vehicle coordinate system in which one axis is the front-rear direction of the subject vehicle and the other axis is the right-left direction of the subject vehicle. The coordinate system to be integrated may also be a route coordinate system. The route coordinate system is a coordinate system in which the center line of the traffic lane in which the vehicle is traveling is defined as one axis, and a direction perpendicular to the center line of the traffic lane is defined as the other axis.

The data integration conversion unit 182 integrates various data and also includes an error calculation unit 182A. The error calculation unit 182A sequentially calculates the lateral error e (t) and the steering error s (t). Here, t means time.

The lateral error e (t) is the difference in distance in the width direction of the traffic lane between the center of the traffic lane in which the vehicle is traveling and the current position of the subject vehicle. The position of the center of the traffic lane during travel is determined based on the lane markings of the traffic lane detected by the external environment sensor 120. Furthermore, if the high-precision map data can be acquired, the position of the center line of the traffic lane during the travel may be acquired or calculated from the high-precision map data. The high precision map data may be stored in a storage device provided in the vehicle, or may be obtained from outside the vehicle via wireless communication. If the road on which the vehicle is traveling does not have traffic lanes, the center of the road in the width direction may be defined as the center of the traffic lane.

The steering error s (t) is the difference between the ideal steering amount and the actual steering amount. The actual steering amount is the steering amount indicated by the steering angle acquired from the subject vehicle state acquisition unit 181, and indicates the amount by which the steering wheel is steered.

The statistical analysis unit 183 acquires the lateral error e (t), the steering error s (t), and the azimuth angle g (t) of the visual line sequentially calculated or acquired by the data integration conversion unit 182. The statistical analysis unit 183 performs statistical analysis based on these values. The statistical analysis unit 183 includes a distribution update unit 183A, a Shannon entropy calculation unit 183B, a divergence calculation unit 183C, and a distribution average calculation unit 183D.

The distribution update unit 183A sequentially updates the distributions of the lateral error e (t), steering error s (t), and azimuth angle g (t) of the visual line. The distribution is represented by a histogram. Each histogram is divided into multiple bins. The number of bins is assumed to be nine below. However, the number of bins may be other than nine. The distribution update unit 183A sequentially updates the short-term distribution for the most recent period and the long-term distribution relatively thereto. The short-term and long-term distributions of the lateral error e (t) are referred to as the short-term lateral error distribution and the long-term lateral error distribution, respectively. The short-term and long-term distributions of the steering error s (t) are defined as the short-term steering error distribution and the long-term steering error distribution, respectively. The short-term and long-term distributions of the azimuth angle g (t) of the visual line are referred to as the short-term visual line azimuth angle distribution and the long-term visual line azimuth angle distribution, respectively.

For example, the short term may be such that the most recent point in chronological time is one end of the period and the other end is any point in time between 5 and 15 seconds in the past. For example, the long term may be defined as a period with the most recent time point as one end and any time point between 30 seconds and 120 seconds in the past as the other end.

The distribution update unit 183A also normalizes each of the distributions. For the normalization, an exponential moving average is calculated. The exponential moving average can be calculated using the following expression (1).

$$\begin{matrix}( Expression 1 ) & \\ {q}_{i} ( t ) = ( 1 - α ) {q}_{i} ( t - 1 ) + α {p}_{i} ( t ) & ( 1 )\end{matrix}$$

In expression (1), i represents each bin. In the following expressions, i has the same meaning. Here, qᵢ(t−1) is the probability density of each bin at time (t−1). pᵢ(t) is the new probability density of each bin at time t (i.e., the current time).

The normalization is performed according to the following expression (2).

$$\begin{matrix}( Expression 2 ) & \\ {\tilde{q}}_{i} ( t ) = \frac{{q}_{i} ( t )}{{\sum }_{j = 1}^{9} {q}_{j} ( t )} & ( 2 )\end{matrix}$$

The Shannon entropy calculation unit 183B sequentially calculates the Shannon entropies Hₑ, Hₛ, and H_{g} of the short-term lateral error, short-term steering error, and short-term visual line azimuth angle. The Shannon entropy H is an index indicating the uncertainty of the histogram, in other words, the spread of the histogram. The Shannon entropies Hₑ, Hₛ, and H_{g} are steering intention change indexes, and the Shannon entropy calculation unit 183B corresponds to a steering intention change index calculation unit.

The Shannon entropy Hₑ of the short-term lateral error is calculated from expression (3) using the normalized distribution of the short-term lateral error. The Shannon entropy Hₛ of the short-term steering error is calculated from the expression (4) using the normalized short-term steering error distribution. The Shannon entropy H_{g} of the short-term visual line azimuth angle is calculated from expression (5) using the normalized distribution of the short-term visual line azimuth angle. In expressions (3), (4), and (5), the subscripts e, s, and g after q tilde indicate the lateral error, steering error, and visual line azimuth angle, respectively.

$$\begin{matrix}( Expression 3 ) & \\ {H}_{e} = - {\sum }_{i = 1}^{9} {\tilde{q}}_{e , i} log ( {\tilde{q}}_{e , i} ) & ( 3 )\end{matrix}$$

$$\begin{matrix}( Expression 4 ) & \\ {H}_{s} = - {\sum }_{i = 1}^{9} {\tilde{q}}_{s , i} log ( {\tilde{q}}_{s , i} ) & ( 4 )\end{matrix}$$

$$\begin{matrix}( Expression 5 ) & \\ {H}_{g} = - {\sum }_{i = 1}^{9} {\tilde{q}}_{g , i} log ( {\tilde{q}}_{g , i} ) & ( 5 )\end{matrix}$$

The divergence calculation unit 183C sequentially calculates the KL divergence between the short-term distribution and the long-term distribution. Specifically, the divergence calculation unit 183C sequentially calculates the KL divergence D_{KLe} between the short-term lateral error distribution and the long-term lateral error distribution (hereinafter referred to as the lateral error KL divergence) and the KL divergence D_{KLs} between the short-term steering error distribution and the long-term steering error distribution (hereinafter referred to as the steering error KL divergence). The KL divergence is a numerical representation of the difference between two probability distributions. The lateral error KL divergence D_{KLe} and the steering error KL divergence D_{KLs} are steering intention change indexes, and the divergence calculation unit 183C corresponds to a steering intention change index calculation unit.

The lateral error KL divergence D_{KLe} is calculated by expression (6), and the steering error KL divergence D_{KLs} is calculated by expression (7).

$$\begin{matrix}( Expression 6 ) & \\ {D}_{{KL}_{e}} = {\sum }_{i = 1}^{9} {\tilde{q}}_{s , e , i} log \frac{{\tilde{q}}_{s , e , i}}{{\tilde{q}}_{l , e , i}} ) & ( 6 )\end{matrix}$$

$$\begin{matrix}( Expression 7 ) & \\ {D}_{{KL}_{s}} = {\sum }_{i = 1}^{9} {\tilde{q}}_{s , s , i} log \frac{{\tilde{q}}_{s , s , i}}{{\tilde{q}}_{l , s , i}} ) & ( 7 )\end{matrix}$$

The distribution average calculation unit 183D sequentially calculates the distribution average μ of the short-term distribution. Specifically, the distribution average calculation unit 183D sequentially calculates the distribution average μₑ of the short-term lateral error distribution, the distribution average μₛ of the short-term steering error distribution, and the distribution average μ_{g} of the short-term visual line azimuth angle distribution. The distribution average is obtained by calculating the product of the class value, i.e., the median value of each bin, and the frequency of that bin for each bin, and then dividing the sum of the products calculated for each bin by the number of data.

The driver intention estimation unit 184 sequentially estimates whether the driver's steering intention is to keep the traffic lane (i.e., LK), to maintain the offset (i.e., OK), or to change the traffic lane (i.e., LC), based on the Shannon entropy H, the KL divergence D_{KL}, and the distribution average μ. The steering intention also includes the intention not to steer in order to keep the vehicle in its traffic lane on a straight road.

In this embodiment, the driver's steering intention is estimated by comparing the following intention estimation index S with first and second thresholds TH1 and TH2 set in advance. The intention estimation index S is expressed by the following expression (8).

$$\begin{matrix}( Expression 8 ) & \\ S = {w}_{e} {S}_{e} + {w}_{s} {S}_{s} + {w}_{g} {S}_{g} & ( 8 )\end{matrix}$$

In expression (8), Sₑ is the lateral error index, Sₛ is the steering error index, and S_{g} is the visual line azimuth angle index. These are values for estimating the steering intention based on the lateral error e, the steering error s, and the visual line azimuth angle g. Here, wₑ, wₛ, and w_{g} are weight vectors by which the lateral error index Sₑ, the steering error index Sₛ, and the visual line azimuth angle index S_{g} are multiplied, respectively. The specific values of the weight vectors are determined based on actual driving data.

A method for calculating the lateral error index Sₑ will be described. When the following traffic lane keeping condition is met, the driver intention estimation unit 184 estimates that the steering intention is to keep the traffic lane (i.e., LK) from the lateral error index Sₑ. In this case, the current lateral error index Sₑ is maintained. In other words, zero is added to the current lateral error index Sₑ.

$$( Traffic lane keeping condition )$$

$${H}_{e} < {T}_{He} , {D}_{KLe} < {T}_{KLe} , and \vert {μ}_{e} \vert < {T}_{μ 1 e}$$

Here, T_{He} is a threshold value for determining whether the Shannon entropy Hₑ of the short-term lateral error is small. When the expression of “Hₑ<T_{He}” is satisfied, the most recent traveling position of the subject vehicle has little variation in the traffic lane width direction. Here, T_{KLe} is a threshold value for determining whether the lateral error KL divergence D_{KLe} is small. When an expression of “D_{KLe}<T_{KLe}” is satisfied, the most recent travel position of the subject vehicle has changed little in the traffic lane width direction from the previous travel position. Here, T_{μ1e} is a threshold value for determining whether the absolute value of the distribution average μₑ of the short-term lateral error distribution is small. When the expression of “|μe|<Tμ1e” is satisfied, there is a high possibility that the subject vehicle is traveling near the center of the traffic lane.

When the following offset maintain condition is met, the driver intention estimating unit 184 estimates that the steering intention indicates the offset maintain travel from the lateral error index Sₑ. In this case, the first additional value is added to the current lateral error index Sₑ. The first additional value is a value smaller than the second additional value described later, and is set to 20, for example. Under the offset maintain condition, T_{μ2e} is a value greater than T_{μ1e}.

$$( Offset maintain condition )$$

$${H}_{e} < {T}_{He} , {D}_{KLe} < {T}_{KLe} , and {T}_{μ 1 e} \leq {\vert}_{{μ}_{e}} \vert < {T}_{μ 2 e}$$

When the expression of “Hₑ<T_{He} and D_{KLe}<T_{KLe}” is satisfied, the current travelling position of the subject vehicle has little variation in the traffic lane width direction, and the change in the traffic lane width direction from the previous travelling position is also small. When the expression of “T_{μ1e}≤|μₑ|<T_{μ2e}” is satisfied, there is a high possibility that the distribution average μₑ of the short-term lateral error distribution is moderately deviated from the center of the traffic lane.

When the following traffic lane change condition is met, the driver intention estimation unit 184 estimates that the steering intention is a traffic lane change LC from the lateral error index Sₑ. In this case, the second additional value is added to the current lateral error index Sₑ. The second additional value is set to, for example, 40.

$$( Traffic lane change condition )$$

$${H}_{e} \geq {T}_{He} , or {D}_{KLe} \geq {T}_{KLe} , or \vert {μ}_{e} \vert \geq {T}_{μ 2 e}$$

When the expression of “Hₑ≥T_{He}” is satisfied, the most recent traveling position of the subject vehicle has a large variation in the traffic lane width direction. When the expression of “D_{KLe}≥T_{KLe}” is satisfied, the most recent position of the subject vehicle has changed significantly from the previous travelling position in the traffic lane width direction. When the expression of “|μₑ|≥T_{μ2e}” is satisfied, there is a high possibility that the subject vehicle is traveling at a position that is shifted from the center of the traffic lane.

The driver intention estimation unit 184 also estimates the steering intention based on the steering error index Sₛ using the traffic lane keeping condition, the offset maintain condition, and the traffic lane change condition described below. In the following conditions, T_{Hs} is a threshold value for determining whether the Shannon entropy Hₛ of the short-term steering error is small. Here, T_{KLs} is a threshold value for determining whether the steering error KL divergence D_{KLs} is small. Here, T_{μ1s} is a threshold value for determining whether the absolute value of the distribution average μₛ of the short-term steering error distribution is small. When the value of T_{μ2s} is greater than T_{μ1s}, and when the expression of “T_{μ1s}≤|μₛ|<Tμ₂ₛ” is satisfied, the distribution average μₛ of the short-term steering error distribution is moderately deviated from the distribution center.

$$( Traffic lane keeping condition )$$

$${H}_{s} < {T}_{Hs} , {D}_{KLs} < {T}_{KLs} , and \vert {μ}_{s} \vert < {T}_{μ1 s}$$

When the expression of “Hs<THs” is satisfied, the most recent travel of the subject vehicle has a small variation in the steering error s. When the expression of “D_{KLs}<T_{KLs}” is satisfied, the difference between the ideal steering amount and the actual steering amount of the subject vehicle has not changed much from the previous difference. When the expression of “|μs|<Tμ1s” is satisfied, the most recent actual steering amount of the subject vehicle is close to the ideal steering amount.

$$( Offset maintain condition )$$

$${H}_{s} < {T}_{Hs} , {D}_{KLs} < {T}_{KLs} , and {T}_{μ 1 s} \leq \vert {μ}_{s} \vert < {T}_{μ2s}$$

When the offset maintain condition is satisfied, the steering error variation in the recent travel of the subject vehicle is small, and the difference between the ideal steering amount and the actual steering amount has not changed much from the previous difference, but the actual steering amount deviates slightly from the ideal steering amount.

$$( Traffic lane change condition )$$

$${H}_{s} \geq {T}_{Hs} , or {D}_{KLs} \geq {T}_{KLs} , or \vert {μ}_{s} \vert \geq {T}_{μ 2 s}$$

When the expression of “Hₛ≥T_{Hs}” is satisfied, the most recent travel of the subject vehicle has had a large variation in the steering error. When the expression of “D_{KLs}≥T_{KLs}” is satisfied, the difference between the ideal steering amount and the actual steering amount for the most recent travel of the subject vehicle has changed significantly compared to the previous travel. When the expression of “|μₛ|≥T_{μ2s}” is satisfied, the actual steering amount for the most recent travel of the subject vehicle has deviated significantly from the ideal steering amount.

Regarding the steering error index Sₛ, when the traffic lane keeping condition is met, the driver intention estimation unit 184 maintains the current steering error index Sₛ. When the offset maintain condition is met, the driver intention estimation unit 184 adds a first additional value to the steering error index Sₛ. When the traffic lane change condition is met, the driver intention estimation unit 184 adds a second additional value to the steering error index Sₛ.

The driver intention estimation unit 184 also estimates the steering intention for the visual line azimuth angle indicator S_{g} using the following traffic lane keeping condition, the offset maintain condition, and the traffic lane change condition. In the following conditions, T_{Hg2} is a threshold value for determining whether the Shannon entropy H_{g} of the short-term visual line azimuth angle is small. Here, T_{Hg1} is a threshold value for determining whether the Shannon entropy H_{g} of the short-term visual line azimuth angle is large. When the expression of “Hg≥THg1” is satisfied, there is a high possibility that the driver is looking at the area ahead of the vehicle. Here, T_{μ1g} is a threshold value for determining that the absolute value of the distribution average μ_{g} of the short-term visual line azimuth angle distribution is small, that is, the driver is looking straight ahead of the subject vehicle on average. Here, T_{μ2g} is a value greater than Tμ_{1g}.

$$( Traffic lane keeping condition )$$

$${H}_{g} \geq {T}_{Hg 1} and \vert {μ}_{g} \vert < {T}_{μ 1 g}$$

$$( Traffic lane change condition )$$

$${H}_{g} < {T}_{Hg 2} and \vert {μ}_{g} \vert \geq {T}_{μ2 g}$$

$$( Offset maintain condition )$$

$${T}_{Hg 2} \leq {H}_{g} < {T}_{Hg 1} , or {T}_{μ1 g} \leq \vert {μ}_{g} \vert < {T}_{μ2 g}$$

Regarding the visual line azimuth angle index S_{g}, when the traffic lane keep condition is met, the driver intention estimation unit 184 maintains the current visual line azimuth angle index S_{g}. When the offset maintain condition is met, the driver intention estimation unit 184 adds a first additional value to the visual line azimuth angle index S_{g}. When the traffic lane change condition is met, the driver intention estimation unit 184 adds a second additional value to the visual line azimuth angle index S_{g}.

The driver intention estimation unit 184 substitutes the lateral direction error index Sₑ, the steering error index Sₛ, and the visual line azimuth angle index S_{g} which are sequentially updated into expression (8) to sequentially update the intention estimation index S. When the expression of “S<TH1” is satisfied, the steering intention is estimated to be the lane keeping operation. When the expression of TH1≤S<TH2” is satisfied, the steering intention is estimated to be the offset maintain operation. When the expression of “S>TH2” is satisfied, the steering intention is estimated to be the lane change operation.

In addition, when it can be determined that the blinker is being operated based on the blinker signal TS, a predetermined value may be added to the intention estimation index S calculated from expression (8), and then the first threshold value TH1 and the second threshold value TH2 may be compared. As a result, when it is determined that the blinker is being operated, it is easier to estimate that the driver's steering intention is to change a traffic lane.

The driver intention estimation unit 184 notifies the ADAS 160 of the estimated steering intention. The ADAS 160 performs one of the following functions according to the driver's intention: the lane keeping function, the lane change function, and the offset maintain function.

The display control unit 185 sequentially displays the steering intention estimated by the driver intention estimation unit 184 on the display device 170.

### (Flow of Processing)

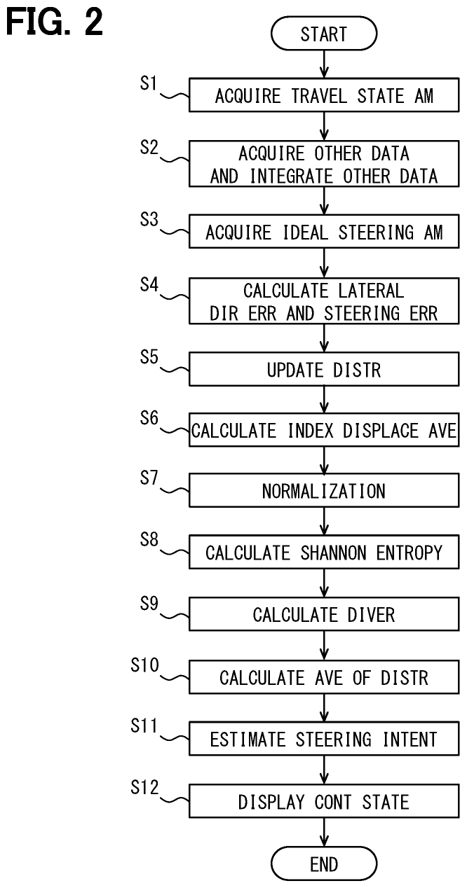

FIG. 2 is a diagram showing an example of a flow of a process executed by a driver intention estimation device 180. The driver intention estimating device 180 repeatedly executes the process shown in FIG. 2. In S1, the subject vehicle state acquisition unit 181 acquires a traveling state amount from the vehicle state amount sensor 110. The travelling state amount includes the steering angle.

Steps S2 to S4 are executed by the data integration conversion unit 182. In S2, the external environment data is acquired from the external environment sensor 120, the position detection data is acquired from the position detection sensor 130, and the visual line measurement data is acquired from the visual line measurement sensor 150. The acquired data is then integrated into data in one coordinate system.

In S3, the ideal steering amount is acquired from the ADAS 160. In S4, the lateral error e and the steering error s are calculated. The lateral error e is the difference in distance between the center of the traffic lane and the current position of the subject vehicle. The center position of the traffic lane is determined from the external environment data, and the current position of the subject vehicle is determined from the position detection data. The steering error s is calculated from the ideal steering amount acquired in S3 and the steering angle acquired in S1.

S5 to S7 are executed by the distribution update unit 183A. In S5, the distribution is updated. Specifically, the short-term lateral error distribution and the long-term lateral error distribution are updated using the latest lateral error e calculated in S4. In addition, the short-term steering error distribution and the long-term steering error distribution are updated using the latest steering error s calculated in S4. In addition, the short-term visual line azimuth angle distribution and the long-term visual line azimuth angle distribution are updated using the latest visual line azimuth angle g indicated by the visual line measurement data acquired in S2.

In S6, the exponential moving average of each distribution updated in S5 is calculated using expression (1). In S7, the exponential moving average calculated in S6 is used to normalize each distribution updated in S5 according to expression (2).

S8 is executed by the Shannon entropy calculation unit 183B. In S8, the Shannon entropy Hₑ of the short-term lateral error, the Shannon entropy Hₛ of the short-term steering error, and the Shannon entropy H_{g} of the short-term visual line azimuth angle are calculated from expressions (3), (4), and (5) based on the short-term lateral error, the short-term steering error, and the short-term visual line azimuth angle normalized in S7.

S9 is executed by the divergence calculation unit 183C. In S9, the lateral error KL divergence D_{KLe} and the steering error KL divergence D_{KLs} are calculated. The lateral error KL divergence D_{KLe} is calculated by substituting the short-term lateral error distribution and the long-term lateral error distribution normalized in S7 into expression (6). The steering error KL divergence D_{KLs} is calculated by substituting the short-term steering error distribution and the long-term steering error distribution normalized in S7 into expression (7).

S10 is executed by the distribution average calculation unit 183D. In S10, the distribution averages μₑ, μₛ, and μ_{g} of the short-term lateral error distribution, short-term steering error distribution, and short-term visual line azimuth angle distribution normalized in S7 are calculated, respectively.

Step S11 is executed by the driver intention estimation unit 184. In S11, the intention estimation index S is updated based on the three Shannon entropies Hₑ, Hₛ, and H_{g} calculated in S9, the two KL divergences D_{KLe} and D_{KLs} calculated in S10, and the three distribution averages μₑ, μₛ, and μ_{g} calculated in S11. The updated intention estimation index S is then compared with the first threshold value TH1 and the second threshold value TH2 to estimate the driver's steering intention.

S12 is executed by the display control unit 185. In S12, the driver's steering intention estimated in S11 is displayed on the display device 170.

In the present embodiment described above, the driver's steering intention is estimated from three factors including not only the lane keeping operation LK and lane change operation LC but also offset maintain operation OK. Therefore, it is possible to prevent the drive support from being provided in a manner that is different from the driver's intention.

The driver's steering intention is estimated based on the Shannon entropy Hₛ of the steering error, the KL divergence D_{KLs} of the steering error, and the distribution average μₛ of the short-term steering error distribution.

The distribution average μₛ of the short-term steering error distribution is an index showing how much the actual steering amount deviates from the ideal steering amount. This distribution average μₛ can be used as an index for estimating the driver's steering intention. However, it may be difficult to accurately estimate the steering intention, including the offset maintain operation at which the position of the subject vehicle' in the road width direction is disposed between the position of the traffic lane keeping operation and the position of the traffic lane change operation, using only the distribution average μₛ. However, in this embodiment, the Shannon entropy Hₛ of the steering error and the KL divergence D_{KLs} of the steering error are also used to estimate the steering intention.

The Shannon entropy Hₛ of the steering error indicates the degree of variation in the difference between the ideal steering amount and the actual steering amount. When the Shannon entropy Hₛ of the steering error is small, there is a high possibility that the driver's steering intention has not changed. Therefore, the Shannon entropy Hₛ of the steering error serves as an index showing whether the driver's steering intention is changing. The steering error KL divergence D_{KLs} indicates the difference between the short-term steering error distribution and the long-term steering error distribution. If there is no change in the driver's steering intention, the steering error KL divergence D_{KLs} will be a small value. Therefore, the steering error KL divergence D_{KLs} also serves as an index showing whether the driver's steering intention is changing. The Shannon entropy Hₛ of the steering error and the steering error KL divergence D_{KLs} change little when the driver continues to keep the traffic lane, but change relatively greatly when the driver changes the traffic lane. Therefore, by estimating the driver's steering intention using the steering error Shannon entropy Hₛ and the steering error KL divergence D_{KLs}, it is possible to accurately estimate whether the driver's steering intention is to keep the traffic lane, to maintain the offset, or to change the traffic lane. Therefore, it is possible to prevent the drive support from being provided in a manner that is different from the driver's intention.

In addition, in this embodiment, in addition to the steering error s, the lateral error e is also calculated, and the driver's steering intention is estimated using the Shannon entropy Hₑ of the lateral error, the KL divergence D_{KLe} of the lateral error, and the distribution average μₑ of the short-term lateral error distribution. The Shannon entropy Hₑ of the lateral error and the KL divergence D_{KLe} of the lateral error are steering intention change indices. Furthermore, the distribution average μₑ of the short-term lateral error distribution can indicate the driver's current steering intention. Therefore, by estimating the driver's steering intention using the Shannon entropy Hₑ of the lateral error, the KL divergence D_{KLe} of the lateral error, and the distribution average μₑ of the short-term lateral error distribution, it is possible to more accurately estimate whether the driver's steering intention is to keep the traffic lane, to maintain the offset, or to change the traffic lane.

In this embodiment, the driver's steering intention is also estimated using the Shannon entropy H_{g} of the short-term visual line azimuth angle and the distribution average μ_{g} of the short-term visual line azimuth angle distribution. The Shannon entropy H_{g} of the short-term visual line azimuth angle is a steering intention change index, and the distribution average μ_{g} of the short-term visual line azimuth angle distribution can indicate the driver's current steering intention. Therefore, by estimating the driver's steering intention using the Shannon entropy H_{g} of the short-term visual line azimuth angle and the distribution average μ_{g} of the short-term visual line azimuth angle distribution, it is possible to more accurately estimate whether the driver's steering intention is to keep the traffic lane, to maintain the offset, or to change the traffic lane.

In addition, in this embodiment, when it can be determined that the blinker is being operated based on the blinker signal TS, it is more likely that the driver's steering intention is to change the traffic lane. This allows the driver's steering intention to be estimated with greater accuracy.

In addition, in this embodiment, the short-term steering error distribution, the long-term steering error distribution, the short-term lateral error distribution, and the long-term lateral error distribution are updated by normalizing them using an exponential moving average. By doing so, each distribution becomes one that is likely to reflect the most recent steering intention.

Although embodiments of the present disclosure have been described above, the present disclosure is not limited to the above-described embodiments, and the following modifications are also included in the present disclosure. Further, various modifications can be made without departing from the spirit of the present disclosure. In the following description, elements having the same reference numerals as those used so far are the same as elements having the same reference numerals in the previous embodiments, except when specifically described. When only a part of the configuration is described, the embodiment described above can be applied to other parts of the configuration.

### First Modification

In the embodiment, a lane keeping condition, a lane change condition, and an offset maintain condition are set, and the driver's steering intention is estimated based on which conditions the Shannon entropy H, KL divergence D_{KL}, and distribution average μ that are sequentially calculated satisfy. Alternatively, the driver's steering intention may be estimated using a method with using machine learning.

An example of a method for estimating a driver's steering intention using machine learning will be described below. As a first step, the input data is prepared. The input data includes Shannon entropy Hₑ, Hₛ, H_{g}, KL divergence D_{KLe}, D_{KLs}, and distribution average Je, μₛ, Ug. The input data may also include the following feature. For example, the input data may include the blinker signal TS, the matching degree between the lateral error e and the steering error s, and data indicating whether the sign of the visual line azimuth angle is consistent with the turn signal light when the turn signal light is turned on.

In the second step, a neural network is constructed. The neural network may be, for example, a multilayer perceptron or a convolutional neural network. The input data is supplied to the input layer. The output layer selectively outputs three signals: lane keep (LK), offset maintain (OK), and lane change (LC).

The third step is to train the neural network. In the learning stage, the learning is performed using the backpropagation method or the like according to the input data calculated from actual driving data and the corresponding steering intention. The fourth stage is a stage in which the steering intention is actually estimated. In the fourth stage, while the vehicle is traveling, the input data is input to the neural network trained in the third stage, and the steering intention estimation results are sequentially obtained.

### Second Modification

In the embodiment, the conditions for estimating the steering intention are the same regardless of whether the current state indicates the lane keep operation (LK), the offset maintain operation (OK), or the lane change operation (LC). Alternatively, hysteresis may be set in the conditions. For example, the condition for changing the driver's steering intention from one state to another may be different from the condition for returning to the previous steering intention after the steering intention has been changed.

Furthermore, a time restriction may be imposed so that after the steering intention of the driver is changed from one state to another, it becomes difficult in the estimation of the steering intention to change to further another state for a certain period of time.

### Third Modification

In the embodiment, an exponential moving average is used to normalize the distribution. Alternatively, instead of the exponential moving average, other averages, for example, a simple moving average, may be used.

### Fourth Modification

In the embodiment, the KL divergence D_{KL} between the short-term error distribution and the long-term error distribution and the Shannon entropy H of the short-term error distribution are calculated as the steering intention change index. Alternatively, only one of these may be calculated. Furthermore, the driver's steering intention may be estimated without using either or both of the lateral error e and the visual line azimuth angle g.

### Fifth Modification

The driver's intention estimation device 180 may include at least one of a processor and a circuit as a hardware configuration. Therefore, the driver's intention estimation device 180 may not be limited to a configuration including a processor, but may be a configuration including no processor and hardware circuits other than a processor, or a configuration including a combination of a processor and hardware circuits other than a processor.

### Technical Feature

This specification discloses multiple technical features described in multiple items listed below. Some features may be described in a multiple dependent form, in which subsequent features alternatively refer to preceding features. In addition, some items may be described in a multiple dependent form referring to another multiple dependent form. These features described in a multiple dependent form define multiple technical features.

### Technical Feature 1

A driver intention estimation device includes: an error calculation unit (182A) that sequentially calculates a steering error(s) that is a difference between an ideal steering amount for performing a traffic lane keeping travel, which is determined based on a shape of a traffic lane on which a vehicle is traveling, and an actual steering amount, which is an amount by which a steering wheel of the vehicle is steered; a steering intention change index calculation unit (183B, 183C) that sequentially calculates a steering intention change index indicating whether a steering intention of a driver of the vehicle is changing based on a short-term steering error distribution that is a distribution of the steering error in a most recent period set in advance; and a driver intention estimation unit (184) that sequentially estimates whether the steering intention of the driver is to keep the traffic lane, to maintain an offset in the traffic lane, or to change the traffic lane based on the steering intention change index and a distribution average of the short-term steering error distribution.

### Technical Feature 2

In the driver intention estimation device according to technical feature 1, the steering intention change index calculation unit sequentially calculates, as the steering intention change index, a steering error KL divergence (D_{KLs}) which is a KL divergence between the short-term steering error distribution and a long-term steering error distribution which is a distribution of the steering error over a longer period than the short-term steering error distribution.

### Technical Feature 3

In the driver intention estimation device according to technical feature 1, the steering intention change index calculation unit sequentially calculates a Shannon entropy (Hₛ) of the steering error as the steering intention change index based on the short-term steering error distribution.

### Technical Feature 4

In the driver intention estimation device according to technical feature 2, the steering intention change index calculation unit sequentially calculates the steering error KL divergence and sequentially calculates a Shannon entropy of the steering error as the steering intention change index based on the short-term steering error distribution. The driver intention estimation unit estimates the steering intention based on the steering error KL divergence, the Shannon entropy of the steering error, and a distribution average of the short-term steering error distribution.

### Technical Feature 5

In the driver intention estimation device according to any one of technical features 1 to 4, the error calculation unit sequentially calculates, in addition to the steering error, a lateral error, which is a difference in a traffic lane width direction between a center of the traffic lane on which the vehicle is traveling and a current position of the vehicle. The steering intention change index calculation unit calculates the steering intention change index based on the short-term steering error distribution, and also sequentially calculates the steering intention change index from a short-term lateral error distribution, which is a distribution of the lateral error in the most recent period. The driver intention estimation unit estimates the steering intention by using the steering intention change index calculated from the short-term lateral error distribution and a distribution average of the short-term lateral error distribution in addition to the steering intention change index calculated from the short-term steering error distribution and a distribution average of the short-term steering error distribution.

### Technical Feature 6

In the driver intention estimation device according to technical feature 5, the steering intention change index calculation unit sequentially calculates, as the steering intention change index, a lateral error KL divergence which is a KL divergence between the short-term lateral error distribution and a long-term lateral error distribution which is a distribution of the lateral error over a longer period than the short-term lateral error distribution.

### Technical Feature 7

In the driver intention estimation device according to technical feature 5, the steering intention change index calculation unit sequentially calculates a Shannon entropy of the lateral error as the steering intention change index based on the short-term lateral error distribution.

### Technical Feature 8

In the driver intention estimation device according to technical feature 6, the steering intention change index calculation unit sequentially calculates the lateral error KL divergence and sequentially calculates a Shannon entropy of the lateral error as the steering intention change index based on the short-term lateral error distribution. The driver intention estimation unit estimates the steering intention by using both the lateral error KL divergence and the lateral error Shannon entropy.

### Technical Feature 9

In the driver intention estimation device according to any one of technical features 1 to 8, the steering intention change index calculation unit sequentially calculates a Shannon entropy of a visual line azimuth angle as the steering intention change index based on a short-term visual line azimuth angle distribution which is a distribution of a visual line azimuth angle of the driver of the vehicle in the most recent period. The driver intention estimation unit estimates the steering intention by using the Shannon entropy of the visual line azimuth angle and a distribution average of the short-term visual line azimuth angle distribution.

### Technical Feature 10

In the driver intention estimation device according to any one of technical features 1 to 9, the driver intention estimation unit further estimates the steering intention of the driver of the vehicle using an operation state of a blinker of the vehicle.

### Technical Feature 11

The driver intention estimation device according to technical feature 2 or 4 further includes a distribution update unit (183A) that updates the short-term steering error distribution and the long-term steering error distribution by normalizing the short-term steering error distribution and the long-term steering error distribution using an exponential moving average. The steering intention change index calculation unit calculates the steering error KL divergence based on a normalized short-term steering error distribution and a normalized long-term steering error distribution.

### Technical Feature 12

The driver intention estimation device according to technical feature 6 or 8 further includes a distribution update unit (183A) that updates the short-term lateral error distribution and the long-term lateral error distribution by normalizing the short-term lateral error distribution and the long-term lateral error distribution using an exponential moving average. The steering intention change index calculation unit calculates the lateral error KL divergence based on the normalized short-term lateral error distribution and the normalized long-term lateral error distribution.

### Technical Feature 13

A driver intention estimation method executed by at least one of a processor and a circuit, the driver intention estimation method includes: sequentially calculating a steering error(s) that is a difference between an ideal steering amount for performing a traffic lane keeping travel, which is determined based on a shape of a traffic lane on which a vehicle is traveling, and an actual steering amount, which is an amount by which a steering wheel of the vehicle is steered; sequentially calculating a steering intention change index indicating whether a steering intention of a driver of the vehicle is changing based on a short-term steering error distribution that is a distribution of the steering error in a most recent period set in advance; and sequentially estimating whether the steering intention of the driver is to keep the traffic lane, to maintain the offset, or to change a traffic lane based on the steering intention change index and the distribution average of the short-term steering error distribution.

In the present disclosure, the term “processor” refers to a processor as a single piece or a plurality of pieces of hardware, and is configured to read a computer program code included in the computer program (i.e., one or more commands of the computer program) each time to execute processing defined by the computer program code. In other words, the “processor” is a hardware device that executes one or more programmed processes. Therefore, the computer program code can also be referred to as software capable of defining the processing of the processor in accordance with the content thereof. The “processor” is a general purpose or specific purpose processor, and may be, for example, a CPU, a microprocessor, a graphics processing unit (GPU), a data flow processor (DFP), or the like, but is not limited thereto.

In this disclosure and in the claims, the term “memory” refers to one or more hardware memories that are non-transitory tangible storage media configured to store computer program code and/or data accessible to a processor. “Memory” may be implemented with memory technologies such as SRAM, SDRAM, non-volatile/flash type memory, or other types of memory. The computer program code constituting the program can be stored in a memory and executed by a processor to cause the processor to realize the various functions described above.

In the present disclosure, the term “circuit” refers to a logic circuit as a single piece or a plurality of pieces of hardware, and is configured to execute specific processing defined based on a pre-designed circuit configuration. In other words, (and in contrast to “processor”), the “circuit” in the present disclosure refers to a hardware device that executes specific processing based on a circuit configuration, rather than processing defined by software such as the above-mentioned computer program code. For example, the “circuit” may include a custom integrated circuit (IC), such as an application-specific integrated circuit (ASIC) or a field-programmable gate array (FPGA), designed using a hardware description language (HDL). That is, the “circuit” in the present disclosure includes all hardware circuits except for the above-mentioned processor that executes processing by reading computer program code.

In the present disclosure, the expression “at least one of the circuit or the processor” should be interpreted in the disjunctive sense (logical sum), and not as at least one circuit and at least one processor.

Reference numeral 100 indicates a drive support system, reference numeral 110 indicates a vehicle state amount sensor, reference numeral 120 indicates an external environment sensor, reference numeral 121 indicates a front camera, reference numeral 122 indicates a millimeter wave radar, reference numeral 123 indicates a LIDAR, reference numeral 130 indicates a position detection sensor, reference numeral 131 indicates a GNSS receiver, reference numeral 140 indicates a blinker signal sensor, reference numeral 150 indicates a visual line measurement sensor, reference numeral 160 indicates an ADAS, reference numeral 170 indicates a display device, reference numeral 180 indicates a driver intention estimation device, reference numeral 181 indicates a vehicle state acquisition unit, reference numeral 182 indicates a data integration conversion unit, reference numeral 182A indicates an error calculation unit, reference numeral 183 indicates a statistical analysis unit, reference numeral 183A indicates a distribution update unit, reference numeral 183 indicates a Shannon entropy calculation unit (i.e., steering intention change index calculation unit), reference numeral 183C indicates a divergence calculation unit (i.e., steering intention change index calculation unit), reference numeral 183D indicates a distribution average calculation unit, reference numeral 184 indicates a driver intention estimation unit, and reference numeral 185 indicates a display control unit.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A driver intention estimation device comprising:
at least one of (i) a circuit and (ii) a processor with a memory storing computer program code executable by the processor, the at least one of the circuit and the processor configured to cause the driver intention estimation device to:
sequentially calculate a steering error that is a difference between an ideal steering amount for performing a traffic lane keeping travel, which is determined based on a shape of a traffic lane on which a vehicle is traveling, and an actual steering amount, which is an amount by which a steering wheel of the vehicle is steered;
sequentially calculate a steering intention change index indicating whether a steering intention of a driver of the vehicle is changing based on a short-term steering error distribution that is a distribution of the steering error in a predetermined most recent period set in advance; and
sequentially estimate whether the steering intention of the driver is to keep the traffic lane, to maintain an offset in the traffic lane, or to change the traffic lane based on the steering intention change index and a distribution average of the short-term steering error distribution.

2. The driver intention estimation device according to claim 1, wherein:
the at least one of the circuit and the processor is configured to further cause the driver intention estimation device to sequentially calculate, as the steering intention change index, a steering error KL divergence which is a KL divergence between the short-term steering error distribution and a long-term steering error distribution which is a distribution of the steering error over a longer period than the short-term steering error distribution.

3. The driver intention estimation device according to claim 1, wherein:
the at least one of the circuit and the processor is configured to further cause the driver intention estimation device to sequentially calculate a Shannon entropy of the steering error as the steering intention change index based on the short-term steering error distribution.

4. The driver intention estimation device according to claim 2, wherein:
the at least one of the circuit and the processor is configured to further cause the driver intention estimation device to sequentially calculate the steering error KL divergence and sequentially calculates a Shannon entropy of the steering error as the steering intention change index based on the short-term steering error distribution; and
the at least one of the circuit and the processor is configured to further cause the driver intention estimation device to estimate the steering intention based on the steering error KL divergence, the Shannon entropy of the steering error, and a distribution average of the short-term steering error distribution.

5. The driver intention estimation device according to claim 1, wherein:
the at least one of the circuit and the processor is configured to further cause the driver intention estimation device to sequentially calculate, in addition to the steering error, a lateral error, which is a difference in a traffic lane width direction between a center of the traffic lane on which the vehicle is traveling and a current position of the vehicle;
the at least one of the circuit and the processor is configured to further cause the driver intention estimation device to calculate the steering intention change index based on the short-term steering error distribution, and also sequentially calculates the steering intention change index from a short-term lateral error distribution, which is a distribution of the lateral error in the predetermined most recent period; and
the at least one of the circuit and the processor is configured to further cause the driver intention estimation device to estimate the steering intention by using the steering intention change index calculated from the short-term lateral error distribution and a distribution average of the short-term lateral error distribution in addition to the steering intention change index calculated from the short-term steering error distribution and a distribution average of the short-term steering error distribution.

6. The driver intention estimation device according to claim 5, wherein:
the at least one of the circuit and the processor is configured to further cause the driver intention estimation device to sequentially calculate, as the steering intention change index, a lateral error KL divergence which is a KL divergence between the short-term lateral error distribution and a long-term lateral error distribution which is a distribution of the lateral error over a longer period than the short-term lateral error distribution.

7. The driver intention estimation device according to claim 5, wherein:
the at least one of the circuit and the processor is configured to further cause the driver intention estimation device to sequentially calculate a Shannon entropy of the lateral error as the steering intention change index based on the short-term lateral error distribution.

8. The driver intention estimation device according to claim 6, wherein:
the at least one of the circuit and the processor is configured to further cause the driver intention estimation device to sequentially calculate the lateral error KL divergence and sequentially calculates a Shannon entropy of the lateral error as the steering intention change index based on the short-term lateral error distribution; and
the at least one of the circuit and the processor is configured to further cause the driver intention estimation device to estimate the steering intention by using both the lateral error KL divergence and the lateral error Shannon entropy.

9. The driver intention estimation device according to claim 1, wherein:
t the at least one of the circuit and the processor is configured to further cause the driver intention estimation device to sequentially calculate a Shannon entropy of a visual line azimuth angle as the steering intention change index based on a short-term visual line azimuth angle distribution which is a distribution of a visual line azimuth angle of the driver of the vehicle in the predetermined most recent period; and
the at least one of the circuit and the processor is configured to further cause the driver intention estimation device to estimate the steering intention by using the Shannon entropy of the visual line azimuth angle and a distribution average of the short-term visual line azimuth angle distribution.

10. The driver intention estimation device according to claim 1, wherein:
the at least one of the circuit and the processor is configured to further cause the driver intention estimation device to further estimate the steering intention of the driver of the vehicle using an operation state of a blinker of the vehicle.

11. The driver intention estimation device according to claim 2, wherein:
the at least one of the circuit and the processor is configured to further cause the driver intention estimation device to update the short-term steering error distribution and the long-term steering error distribution by normalizing the short-term steering error distribution and the long-term steering error distribution using an exponential moving average; and
the at least one of the circuit and the processor is configured to further cause the driver intention estimation device to calculate the steering error KL divergence based on a normalized short-term steering error distribution and a normalized long-term steering error distribution.

12. The driver intention estimation device according to claim 6, wherein:
the at least one of the circuit and the processor is configured to further cause the driver intention estimation device to update the short-term lateral error distribution and the long-term lateral error distribution by normalizing the short-term lateral error distribution and the long-term lateral error distribution using an exponential moving average; and
the at least one of the circuit and the processor is configured to further cause the driver intention estimation device to calculate the lateral error KL divergence based on the normalized short-term lateral error distribution and the normalized long-term lateral error distribution.

13. The driver intention estimation device according to claim 1, wherein:
the at least one of the circuit and the processor is configured to cause the driver intention estimation device to: sequentially calculate a steering error that is a difference between an ideal steering amount for performing a traffic lane keeping travel, which is determined based on a shape of a traffic lane on which a vehicle is traveling, and an actual steering amount, which is an amount by which a steering wheel of the vehicle is steered, as an error calculation unit;
the at least one of the circuit and the processor is configured to cause the driver intention estimation device to: sequentially calculate a steering intention change index indicating whether a steering intention of a driver of the vehicle is changing based on a short-term steering error distribution that is a distribution of the steering error in a predetermined most recent period set in advance, as a steering intention change index calculation unit; and
the at least one of the circuit and the processor is configured to cause the driver intention estimation device to: sequentially estimate whether the steering intention of the driver is to keep the traffic lane, to maintain an offset in the traffic lane, or to change the traffic lane based on the steering intention change index and a distribution average of the short-term steering error distribution, as a driver intention estimation unit.

14. The driver intention estimation device according to claim 1, wherein:
the driver intention estimation device executes a drive support of the vehicle based on an estimated steering intention of the driver.

15. The driver intention estimation device according to claim 14, further comprising:
an Advanced Driver-Assistance Systems for controlling a steering device and an acceleration/deceleration device mounted on the vehicle to execute a steering control and a speed control of the vehicle, wherein:
the driver intention estimation device executes the drive support of the vehicle by performing the speed control and the steering control of the vehicle through the Advanced Driver-Assistance Systems.

16. The driver intention estimation device according to claim 15, wherein:
the Advanced Driver-Assistance Systems performs the speed control and the steering control of the vehicle to keep the traffic lane, to maintain an offset in the traffic lane, or to change the traffic lane based on the steering intention change index and the distribution average of the short-term steering error distribution.

17. A non-transitory computer readable storage medium comprising instructions being executed by a computer, the instructions including a computer-implemented method for a driver intention estimation method, the instructions causing the computer to function as:
an error calculation unit that sequentially calculates a steering error that is a difference between an ideal steering amount for performing a traffic lane keeping travel, which is determined based on a shape of a traffic lane on which a vehicle is traveling, and an actual steering amount, which is an amount by which a steering wheel of the vehicle is steered;
a steering intention change index calculation unit that sequentially calculates a steering intention change index indicating whether a steering intention of a driver of the vehicle is changing based on a short-term steering error distribution that is a distribution of the steering error in a predetermined most recent period set in advance; and
a driver intention estimation unit that sequentially estimates whether the steering intention of the driver is to keep the traffic lane, to maintain an offset in the traffic lane, or to change the traffic lane based on the steering intention change index and a distribution average of the short-term steering error distribution.

18. A driver intention estimation method executed by at least one of a processor and a circuit, the driver intention estimation method comprising:
sequentially calculating a steering error that is a difference between an ideal steering amount for performing a traffic lane keeping travel, which is determined based on a shape of a traffic lane on which a vehicle is traveling, and an actual steering amount, which is an amount by which a steering wheel of the vehicle is steered;
sequentially calculating a steering intention change index indicating whether a steering intention of a driver of the vehicle is changing based on a short-term steering error distribution that is a distribution of the steering error in a most recent period set in advance; and
sequentially estimating whether the steering intention of the driver is to keep the traffic lane, to maintain the offset, or to change a traffic lane based on the steering intention change index and the distribution average of the short-term steering error distribution.
